(19) United States
(12) Patent Application Publication
(10) Pub. No.: US 2018/0277070 A1
(43) Pub. Date: Sep. 27, 2018

(54) ELECTRONIC CYMBAL

(71) Applicant: ATV corporation, Hamamatsu-shi (JP)

(72) Inventor: Yoshiaki MORI, Shizuoka (JP)

(21) Appl. No.: 15/869,351

(22) Filed: Jan. 12, 2018

(30) Foreign Application Priority Data
Mar. 21, 2017 (JP) 2017-054255

(51) Int. Cl. G10D 13/02; G10H 3/14; G10D 13/06

(52) U.S. Cl. CPC G10D 13/024; G10H 3/146; G10H 2230/321; G10D 13/06; G10H 3/143

(57) ABSTRACT

An electronic cymbal includes: a base body having a through-hole at a center; a pad made of a material with elasticity, the pad including a surface hit by a player with the surface covering a first surface of the base body; and a hitting sensor disposed adjacent to the through-hole on a second surface side of the base body, the hitting sensor being configured to detect the hitting to the pad. The pad includes a cup portion, the cup portion includes a part of the pad bulging into a convex shape and being separated from the first surface, the cup portion forming a void between the cup portion and the first surface by the separation, and the pad further includes a joint, the joint drooping from an inner surface of the cup portion to contact the first surface of the base body.

### CROSS-REFERENCE TO RELATED APPLICATION

This application claims priority from Japanese Patent Application No. 2017-054255 filed with the Japan Patent Office on Mar. 21, 2017, the entire content of which is hereby incorporated by reference.

### BACKGROUND

### 1. Technical Field

This disclosure relates to an electronic cymbal.

### 2. Description of the Related Art

Generally, an electronic cymbal is a cymbal or a hi-hat electronically achieved using an electronic circuit. The electronic cymbal includes a base body and a pad. The base body is circularly formed with a hard material such as a metal. The pad is made of an elastic body such as a rubber and covers an outer surface of the base body. For example, an electronic hi-hat cymbal disclosed in JP-A-2002-196753 includes a cup portion bulging into a convex shape at the center of the cymbal, and a cover and a frame are mutually in close contact. With an electronic cymbal disclosed in JP-A-2002-062872, a cover and a frame are separated from one another at a cup portion, forming a hollow. In these cases, piezoelectric sensors to detect hitting to the cover are disposed at respective frames in the electronic hi-hat cymbal and the electronic cymbal.

### SUMMARY

An electronic cymbal includes: a base body having a through-hole at a center; a pad made of a material with elasticity, the pad including a surface hit by a player with the surface covering a first surface of the base body; and a hitting sensor disposed adjacent to the through-hole on a second surface side of the base body, the hitting sensor being configured to detect the hitting to the pad. The pad includes a cup portion, the cup portion includes a part of the pad opposed to a position corresponding to a back side of the hitting sensor in the first surface of the base body, the part bulging into a convex shape and being separated from the first surface, the cup portion forming a void between the cup portion and the first surface by the separation, and the pad further includes a joint, the joint drooping from an inner surface of the cup portion to contact the first surface of the base body.

### BRIEF DESCRIPTION OF THE DRAWINGS

FIG. 1 is a perspective view illustrating a schematic external configuration of main parts of an electronic cymbal according to one embodiment of this disclosure;

FIG. 2 is an enlarged cross-sectional view illustrating a schematic internal configuration of the electronic cymbal illustrated in FIG. 1;

FIG. 3 is an enlarged cross-sectional view illustrating a schematic internal configuration of main parts of an electronic cymbal according to a modification of this disclosure;

FIG. 4 is an enlarged cross-sectional view illustrating a state of hitting a cup portion of the electronic cymbal illustrated in FIG. 3; and

FIG. 5 is an enlarged cross-sectional view illustrating a schematic internal configuration of main parts of an electronic cymbal according to another modification of this disclosure.

### DESCRIPTION OF THE EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

With the electronic hi-hat cymbal disclosed in JP-A-2002-196753, the cup portion of the cymbal has a thickness thicker than a bow portion and an edge portion outside with respect to the cup portion on the upper cymbal. Accordingly, hitting with weak strength to this cup portion (hereinafter sometimes referred to as “weak hitting”) is less likely to be detected, resulting in low detection accuracy. The electronic cymbal disclosed in JP-A-2002-062872 forms the hollow below the cup portion. Accordingly, the weak hitting to this cup portion is less likely to be detected, resulting in low detection accuracy.

An object of this disclosure is to provide an electronic cymbal that can highly accuracy detect weak hitting to a cup portion of the cymbal.

An electronic cymbal according to one aspect of the present disclosure (the present electronic cymbal) includes: a base body having a through-hole at a center; a pad made of a material with elasticity, the pad including a surface hit by a player with the surface covering a first surface of the base body; and a hitting sensor disposed adjacent to the through-hole on a second surface side of the base body, the hitting sensor being configured to detect the hitting to the pad. The pad includes a cup portion, the cup portion includes a part of the pad opposed to a position corresponding to a back side of the hitting sensor in the first surface of the base body, the part bulging into a convex shape and being separated from the first surface, the cup portion forming a void between the cup portion and the first surface by the separation, and the pad further includes a joint, the joint drooping from an inner surface of the cup portion to contact the first surface of the base body.

The present electronic cymbal includes the cup portion forming the void and the joint in contact with the base body. Therefore, the electronic cymbal can efficiently guide the weak hitting to a pad to the hitting sensor while restraining both attenuation of vibrations caused by a thick thickness and attenuation of vibrations caused by the void.

The present electronic cymbal may have the joint formed to have an intermittent or a continuous annular shape.

With this aspect, with the electronic cymbal, the joint is formed into an intermittent or a continuous annular shape. In view of this, regardless of a hitting position in a circumferential direction of the cup portion, the vibrations by the hitting can be accurately transmitted to the base body.

In the present electronic cymbal, the pad may further include an isolation support pillar, the isolation support pillar drooping from the inner surface of the cup portion and being opposed to the first surface of the base body via a clearance. The clearance between the isolation support pillar and the first surface may have an amount of clearance where the isolation support pillar contacts the first surface when the player hits the pad.

With this aspect, the pad of the present electronic cymbal further includes the isolation support pillar. The isolation support pillar droops from the inner surface of the cup portion and is opposed to the first surface of the base body via the clearance. In this case, the clearance between the isolation support pillar and the first surface of the base body has the amount of clearance where the isolation support pillar contacts the first surface of the base body when the player hits the cup portion. Specifically, the amount of clearance is preferably in a range of 0.2 mm or more to 2 mm or less. With the electronic cymbal, this isolation support pillar allows the cup portion in the pad to have appropriate rigidity. Specifically, with the electronic cymbal, when the cup portion is hit weakly, the rigidity of the cup portion by the isolation support pillar contactless to the base body or rigidity of the cup portion by the contact of the isolation support pillar to the base body can be improved. Furthermore, when the cup portion is strongly hit, the rigidity of the cup portion by the close contact of the isolation support pillar with the base body can be improved. These configurations of the electronic cymbal allow the player to have a sense of hitting close to an acoustic cymbal.

The isolation support pillar may be formed to have a thickness thicker than the joint.

With this aspect, the isolation support pillar of the electronic cymbal is formed to have the thickness thicker than the joint. Therefore, when the cup portion is strongly hit, this configuration ensures restraining the squash of the joint leading to damage.

The isolation support pillar may be formed to have an intermittent or a continuous annular shape at a position radially inside the pad with respect to the joint in the inner surface of the cup portion.

With this aspect, the isolation support pillar of the electronic cymbal is formed to have an intermittent or a continuous annular shape at the position radially inside the pad with respect to the joint in the inner surface of the cup portion. Therefore, the length of the joint in the vertical direction can be shorter than the isolation support pillar. This ensues efficiently transmitting the weak hitting to the cup portion to the base body. Furthermore, regardless of the hitting position in the circumferential direction of the cup portion, the damage of the joint caused by the squash can be restrained.

In the present electronic cymbal, the joint may be tapered off to the first surface of the base body.

With this aspect, the joint of the electronic cymbal is formed to have the shape tapered off to the first surface of the base body. Accordingly, the joint can widely receive the vibrations from the cup portion. Furthermore, the joint can restrain the attenuation in the process of transmitting the vibrations to the base body. Consequently, the joint can further efficiently guide the vibrations by the weak hitting to the hitting sensor. With this aspect, since the distal end side of the joint is thin, the distal end is likely to deform. In view of this, when the cup portion is strongly hit, the distal end of the joint deforms to increase the contacted area between the joint and the base body. This ensures restraining the local concentration of the large vibrations to a part of the base body via the joint. Consequently, the excessive reaction or damage of the hitting sensor can be restrained.

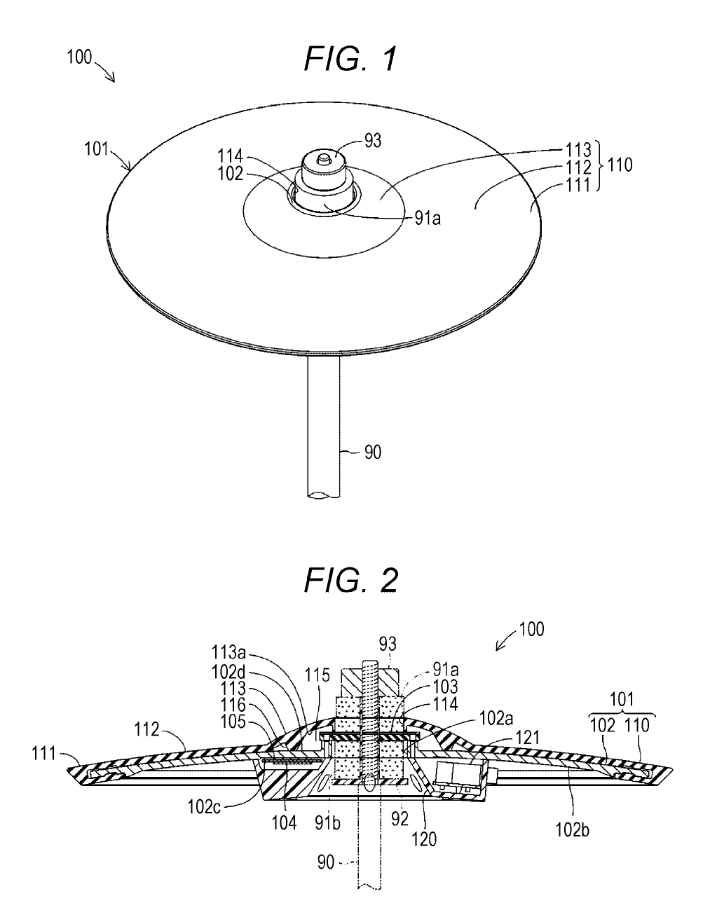

The following describes one embodiment of the electronic cymbal according to this disclosure with reference to the drawings. FIG. 1 is a perspective view illustrating a schematic external configuration of main parts of an electronic cymbal 100 according to the embodiment. FIG. 2 is an enlarged cross-sectional view illustrating a schematic internal configuration of the electronic cymbal 100 illustrated in FIG. 1.

Note that the drawings to be referred in this description are schematically illustrated for ease of understanding of the technique of this disclosure by exaggeratedly illustrating a part of components and the like. Therefore, dimensions, ratios, and the like between the respective components may differ between the actual components and the illustrated components.

This electronic cymbal 100 is an electronic musical instrument that detects an impact to a struck surface hit by a player (not illustrated) via a stick (not illustrated) to generate an electronic musical sound.

(Configuration of Electronic Cymbal 100)

The electronic cymbal 100 includes a head 101. The head 101 is a component that vibrates by a hitting operation by the player. The head 101 curves into a convex shape upward and is formed of a plate-shaped body with a circular shape in plan view. This head 101 mainly includes a base body 102, hitting sensors (first hitting sensors) 104, a pad 110, and a lower surface cover 120.

The base body 102 is a component becoming a core material shaping the head 101. The base body 102, for example, is configured by curving a metal material or a resin material into the convex shape upward and forming the material into the circular ring plate-shaped body in plan view. A mounting hole 102a is formed at the center of this base body 102. The mounting hole 102a is a part through which a rod-shaped stand 90 passes. The rod-shaped stand 90 is used to support this electronic cymbal 100 at a predetermined height position. A holding plate 103 is disposed at an upper end surface of this mounting hole 102a in FIG. 2.

The holding plate 103 is a component to mount the base body 102 to the stand 90. The holding plate 103 is configured by forming a rubber material into a circular ring shape in plan view. Here, the stand 90 is a metallic instrument extending in a columnar shape. The stand 90 is used to hold the head 101 at a predetermined height from the floor surface. Note that FIGS. 1 and 2 illustrate the stand 90 omitting the lower part.

This holding plate 103 is securely mounted to the base body 102 with a mounting bolt inserted from a lower surface 102b side of the base body 102. The holding plate 103 is sandwiched between two pressing tools 91a and 91b through which the stand 90 passes to be held to the stand 90. Here, the two pressing tools 91a and 91b are both configured by forming a felt material into a tubular shape. These two pressing tools 91a and 91b are cylindrical bodies through which the stand 90 passes. The pressing tools 91a and 91b are sandwiched between a lower support tube 92 where a flange is formed and a nut 93 fitted to an upper end of the stand 90 with a screw to be supported (held) to the stand 90. Note that FIG. 2 illustrates the stand 90, the pressing tools 91a and 91b, and other components accompanied by the stand 90 by the two-dot chain lines.

A mounting portion 102c is formed at the lower surface 102b of the base body 102. The mounting portion 102c is a part depressed into a depressed shape formed at the peripheral area of the mounting hole 102a. Three hitting sensors 104 (only the one hitting sensor 104 is illustrated) are disposed at this mounting portion 102c. That is, the hitting sensors 104 are disposed adjacent to the mounting hole (the through-hole) 102a on the lower surface 102b (the second surface) side of the base body 102. The three hitting sensors 104 detect the hitting to the head 101 (the pad 110). The hitting sensors 104 are, for example, detectors to detect the vibrations by the hitting to the head 101 (the pad 110). The hitting sensors 104 output detection signals constituted of electrical signals corresponding to the vibrations of the base body 102 to a signal processing device (not illustrated).

The hitting sensors 104 of this embodiment each include a piezo element. This piezo element includes electrodes on respective both surfaces of a piezoelectric ceramic. Furthermore, a metal plate is disposed at one of these electrodes. These three hitting sensors 104 are connected to an output terminal 121 via an electrical wiring (not illustrated). The hitting sensors 104 are electrically connected to the signal processing device via this output terminal 121.

Here, the signal processing device includes a microcomputer disposed separately from the electronic cymbal 100. The signal processing device is an electronic circuit that outputs musical sound signals based on the detection signals output from the three hitting sensors 104, namely, a sound source. To this signal processing device, an external speaker (not illustrated) is connected.

These three hitting sensors 104 are disposed uniformly in the circumferential direction of the mounting portion 102c around the mounting hole 102a. The respective hitting sensors 104 are mounted to the mounting portion 102c with two-sided adhesive tapes 105. In this case, the two-sided adhesive tapes 105 are formed so as to have an outer diameter smaller than an outer diameter of the respective hitting sensors 104. With these two-sided adhesive tapes 105, the three hitting sensors 104 are mounted to the mounting portion 102c while the outer edges of the electrodes having the circular plate shape in plan view are separated from the surface of the mounting portion 102c.

The pad 110 is made of a material with elasticity and includes a surface hit by the player covering the one surface of the base body 102. That is, the pad 110 is a part constituting a struck surface hit by the player using the stick or the like. The pad 110 is configured by forming an elastic body made of a rubber material, a foamed resin material, or the like into a circular ring shape covering the top surface and the outer edge of the base body 102. More specifically, the pad 110 mainly includes an edge portion 111, a bow portion 112, and a cup portion 113.

The edge portion 111 is a part covering the edge of the base body 102. The edge portion 111 is formed so as to wrap in the outer edge of the top surface and the outer edge of the lower surface 102b of the base body 102. The bow portion 112 is constituted as an inclined surface gradually rising from the edge portion 111 to the cup portion 113. The inner surface of this bow portion 112 is in close contact with the top surface of the base body 102.

The cup portion 113 includes a part of the pad 110 opposed to positions corresponding to the back sides of the hitting sensors 104 on a back side surface (a first surface) 102d of the base body 102. This part bulges into the convex shape and is separated from the back side surface 102d. Accordingly, the cup portion 113 forms a void between the cup portion 113 and the back side surface 102d. That is, the cup portion 113 is configured as an inclined surface that budges up into the convex shape from the innermost peripheral part of the bow portion 112 to a through-hole 114, which is formed at the center of the pad 110, at an angle steeper than the bow portion. More specifically, the cup portion 113 is formed above the hitting sensors 104 disposed at the base body 102 so as to overlap with the hitting sensors 104. In this case, the cup portion 113 has an inner surface 113a. The inner surface 113a is opposed to the back side surface 102d of the mounting portion 102c where the hitting sensors 104 are disposed in the base body 102. The inner surface 113a is also constituted as the inclined surface and is separated from the back side surface 102d of the base body 102. Accordingly, a void 115 is formed between the cup portion 113 and the base body 102. The void 115 is an annular space disposed outside the mounting hole 102a and the through-hole 114.

The cup portion 113 is formed to have a thickness equal to or more than the thickness of the bow portion 112. The thickness of the cup portion 113 in this embodiment is formed thicker than the thickness of the bow portion 112. A joint 116 is formed at the inner surface 113a of this cup portion 113.

The joint 116 is a part to transmit the vibrations by the hitting to the cup portion 113 to the base body 102. The joint 116 droops from the inner surface 113a of the cup portion 113 and contacts the back side surface 102d of the base body 102. More specifically, the joint 116 is formed integrally with the cup portion 113. The joint 116 projects out from the inner surface 113a of the cup portion 113 to the back side surface 102d of the base body 102 as a continuous annular member. Furthermore, the joint 116 has a shape tapered off from the inner surface 113a of the cup portion 113 to the back side surface 102d of the base body 102. That is, the joint 116 has a thin distal end (the lower end illustrated in the drawing). This distal end of the joint 116 contacts the back side surface 102d of the base body 102. In this case, the joint 116 (the distal end of the joint 116) preferably contacts the position (the back side of the mounting portion 102c) of the back side surface 102d of the base body 102 that overlaps with the contact positions of the base body 102 with the hitting sensors 104 in plan view.

Note that, in this embodiment, the head 101 is made of two kinds of materials, the material of the base body 102 (the metal material or the resin material) and the material of the pad 110 (the elastic body). Instead of this, the head 101 can be constituted of one kind of material, for example, only the resin material or only a fiber-reinforced plastic containing the resin material.

The lower surface cover 120 is a component mounted to the lower surface 102b of the base body 102. The lower surface cover 120 covers the mounting portion 102c and the hitting sensors 104 mounted to this mounting portion 102c. Furthermore, the lower surface cover 120 houses the output terminal 121. The lower surface cover 120 is configured by forming the resin material into a cylindrical shape in plan view. In this case, the lower surface cover 120 houses the output terminal 121 exposed to the outside. This lower surface cover 120 is mounted to the lower surface 102b of the base body 102 with the mounting bolt (not illustrated).

The output terminal 121 is a jack type interface to insert a signal cable (not illustrated). The signal processing device, which is disposed outside the electronic cymbal 100, and the hitting sensors 104 can be connected by this signal cable. This ensures outputting the detection signals output from the respective hitting sensors 104 to the signal processing device.

(Operations of Electronic Cymbal 100)

The following describes the operations of the electronic cymbal 100 configured as described above. First, the player attaches the electronic cymbal 100 to the stand 90. Afterwards, the player electrically connects the output terminal 121 and the signal processing device via the signal cable (not illustrated). This makes the performance with the electronic cymbal 100 possible.

Next, the player plays the electronic cymbal 100. Specifically, the player hits that top surface of the head 101 using the stick. In this case, with the head 101, when the edge portion 111 and the bow portion 112 in the pad 110 are hit, the vibrations occurred in the pad 110 are mainly directly transmitted to the base body 102 in close contact with the pad 110 and are detected by the hitting sensors 104. Meanwhile, with the head 101, when the cup portion 113 in the pad 110 is hit, the vibrations occurred in the pad 110 are mainly transmitted to the base body 102 in close contact with the pad 110 via the joint 116 and are detected by the hitting sensors 104.

Thus, the respective hitting sensors 104 output the detection signals according to the vibrations propagated via both the pad 110 and the base body 102 to the signal processing device via the output terminal 121. Accordingly, the signal processing device generates the musical sound signals representing a musical sound based on a sum signal, which is a sum of the detection signals output from the respective hitting sensors 104, to the external speaker. Consequently, the electronic cymbal 100 can output the musical sound according to the performance operation by the player from the external speaker.

When the player finishes the performance with the electronic cymbal 100, after removal the electrical connection between the electronic cymbal 100 and the signal processing device, the player removes the electronic cymbal 100 from the stand 90. This allows the player to finish the performance with the electronic cymbal 100.

As can be understood from the above-described explanation on the operations, according to the embodiment, the electronic cymbal 100 includes the cup portion 113 including the joint 116. The cup portion 113 forms the void 115, and the joint 116 contacts the base body 102. This ensures efficiently guiding the weak hitting to the pad 110 to the hitting sensors 104 while restraining both the attenuation of the vibration caused by the thick thickness of the cup portion 113 and the attenuation of the vibration caused by the void 115.

Furthermore, the aspects of this disclosure are not limited to the above-described embodiments. The embodiments can be variously changed as long as not departing from the object of the technique of this disclosure. Note that like reference numerals designate identical elements throughout the embodiments and the following respective modifications, and therefore such elements will not be further elaborated here.

For example, with the respective embodiments, the joint 116 is formed to have the continuous annular shape drooping from the inner surface 113a of the cup portion 113. Meanwhile, it is only necessary that the joint 116 is configured to droop from the inner surface 113a of the cup portion 113 and contact the back side surface 102d of the base body 102. Accordingly, the joint 116 may be formed to have the intermittent annular shape drooping from the inner surface 113a of the cup portion 113. Alternatively, the joint 116 may be formed to droop to a part of the inner surface 113a in a cantilevered manner. A plurality of the joints 116 may be disposed along the radial direction of the inner surface 113a of the cup portion 113.

With the embodiment, the joint 116 is formed so as to have a shape tapered off (have the thin distal end) from the inner surface 113a side of the cup portion 113 to the back side surface 102d of the base body 102. Accordingly, the joint 116 can widely recover the vibrations from the cup portion 113. Furthermore, the joint 116 can restrain the attenuation in the process of transmitting the vibrations to the base body 102. Consequently, the joint 116 can further efficiently guide the vibrations by the weak hitting to the hitting sensors 104. With the electronic cymbal 100, since the distal end side of the joint 116 is thin, the distal end is likely to deform. In view of this, when the cup portion 113 is strongly hit, the distal end of the joint 116 deforms to increase the contacted area between the joint 116 and the base body 102. This ensures restraining the local concentration of the large vibrations to a part of the base body 102 via the joint 116. Consequently, the excessive reaction or damage of the hitting sensors 104 can be restrained. Note that the strong hitting means skillful hitting at strength equal to or more than the strength during the weak hitting.

Meanwhile, the joint 116 may be formed to have the constant thickness from the inner surface 113a side of the cup portion 113 to the back side surface 102d of the base body 102. Alternatively, the joint 116 can be formed to have the thickness thickening from the inner surface 113a side of the cup portion 113 to the back side surface 102d of the base body 102.

With the embodiment, the joint 116 is integrally molded with the cup portion 113 with the material identical to the cup portion 113 (that is, the pad 110). Meanwhile, the material of the joint 116 may be identical to or different from the material of the cup portion 113. The joint 116 may be configured as the member separately from the cup portion 113.

With the embodiment, the joint 116 (the distal end of the joint 116) is configured so as to contact the position of the back side surface 102d of the base body 102 corresponding to the approximately center position of the mounting positions of the hitting sensors 104 (the contact positions with hitting sensors 104) in the base body 102. The joint 116 (the distal end of the joint 116) preferably contacts the position (the back side of the mounting portion 102c) of the back side surface 102d of the base body 102 that overlaps with the mounting positions of the hitting sensors 104 to the base body 102 in plan view. Note that, the joint 116 needs not be disposed so as strictly contact the position at the back side surface 102d of the base body 102 corresponding to the mounting positions. The joint 116 may be disposed so as to contact the peripheral area of the position at the back side surface 102d of the base body 102 corresponding to the mounting positions.

With the embodiment, the joint 116 is configured to contact the back side surface 102d of the base body 102. Meanwhile, the joint 116 may be configured so as to contact the hitting sensors 104 disposed on the back side surface 102d of the base body 102 directly or indirectly via an elastic body or the like.

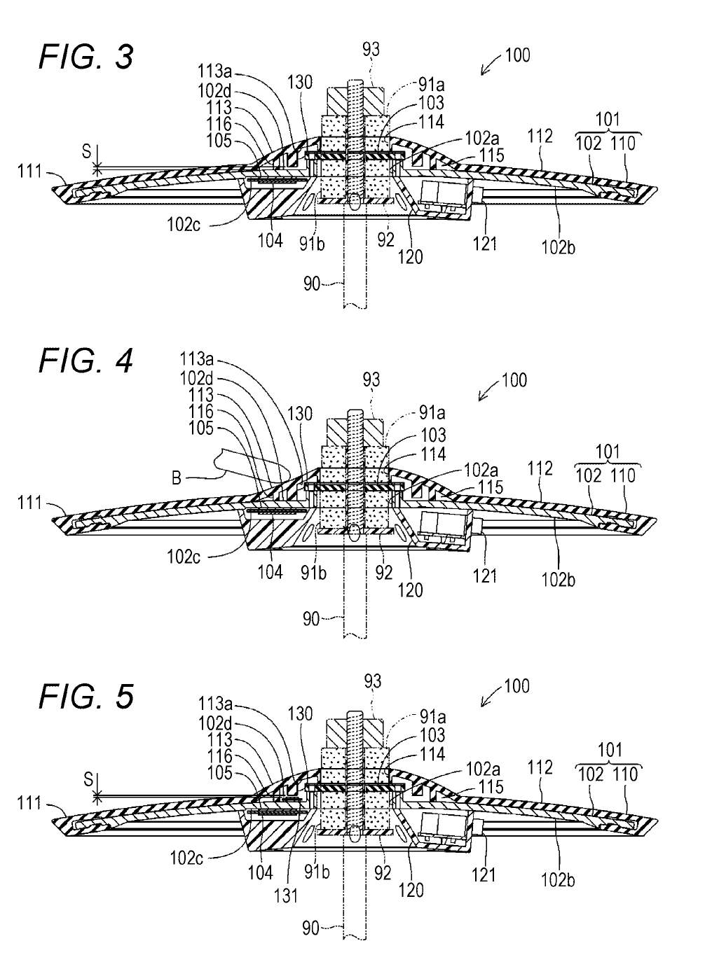

With the embodiment, the annular joint 116 is disposed at the inner surface 113a of the cup portion 113. Meanwhile, as illustrated in in FIG. 3, an isolation support pillar 130 may be disposed at the cup portion 113 in addition to the joint 116. This isolation support pillar 130 droops from the inner surface 113a and is opposed to the back side surface 102d of the base body 102 via a clearance S.

In this case, the isolation support pillar 130 can be formed to have a continuous annular shape at a position radially inside the pad 110 with respect to the joint 116 in the inner surface 113a. The clearance S between the lower end of the isolation support pillar 130 and the base body 102 has a size (an amount of clearance) where the lower end of the isolation support pillar 130 contacts the base body 102 (the back side surface 102d of the base body 102) when the player hits the cup portion 113. Specifically, the clearance S preferably has the size in a range of 0.2 mm or more to 2 mm or less.

With the electronic cymbal 100, this isolation support pillar 130 allows the cup portion 113 in the pad 110 to have appropriate rigidity. Specifically as illustrated in in FIG. 4, with the electronic cymbal 100, when the cup portion 113 is hit weakly with a stick B, the rigidity of the cup portion 113 by the isolation support pillar 130 contactless to the base body 102 or rigidity of the cup portion 113 by the contact of the isolation support pillar 130 to the base body 102 can be improved. Furthermore, when the cup portion 113 is strongly hit, the rigidity of the cup portion 113 by the close contact of the isolation support pillar 130 with the base body 102 can be improved. These configurations of the electronic cymbal 100 allow the player to have a sense of hitting close to an acoustic cymbal. Additionally, the isolation support pillar 130 may be formed to have the thickness thicker than the joint 116. Therefore, when the cup portion 113 is strongly hit, this configuration ensures restraining the squash of the joint 116 leading to damage.

In this case, as illustrated in in FIG. 5, the electronic cymbal 100 may include at least one hitting sensor (a second hitting sensor) 131. The hitting sensor 131 is disposed at a position opposed to the isolation support pillar 130 on the back side surface 102d of the base body 102. In this case, the two, three, four, or more than four hitting sensors 131 can be uniformly disposed along the circumferential direction of the isolation support pillar 130. This hitting sensor 131 outputs the detection signals according to the pressure caused by the contact with the isolation support pillar 130 and the vibrations transmitted by the contact with the isolation support pillar 130 to the signal processing device via the output terminal 121.

With this configuration, hitting the cup portion 113 brings the isolation support pillar 130 in contact with the hitting sensor 131. The hitting sensor 131 outputs the detection signals according to the pressure and the vibration during the contact to the signal processing device. This allows the signal processing device to detect the hitting to the cup portion 113 in the pad 110 using the detection signals output from the hitting sensor 131. Consequently, the signal processing device can generate the musical sound signals when the cup portion 113 is hit. The signal processing device may be configured such that the detection signals are individually received from the plurality of hitting sensors 131. This allows the signal processing device to specify the hitting position at the cup portion 113. Consequently, the signal processing device can also generate the musical sound according to the specified hitting position.

Note that the isolation support pillar 130 can be formed to have the thickness identical to the joint 116 or the thickness thinner than the joint 116. A plurality of the isolation support pillars 130 can be disposed along the radial direction of the pad 110. The isolation support pillar 130 can be disposed radially outside the pad 110 with respect to the joint 116. The isolation support pillar 130 may have a shape tapered off from the inner surface 113a side of the cup portion 113 to the back side surface 102d of the base body 102. That is, the isolation support pillar 130 may have the thin distal end. Alternatively, the isolation support pillar 130 may have a constant thickness. Alternatively, the isolation support pillar 130 may have a shape thickening to the back side surface 102d. That is, the isolation support pillar 130 may have the thick distal end. The isolation support pillar 130 may be formed to have the intermittent annular shape drooping from the inner surface 113a of the cup portion 113. Alternatively, the isolation support pillar 130 may be formed to droop to a part of the inner surface 113a in a cantilevered manner.

With the embodiment, the signal processing device functions as the sound source. Meanwhile, the signal processing device can be configured as various devices that perform a process to generate the musical sound using the detection signals output from the hitting sensors. Accordingly, for example, the signal processing device may include an A/D converter that converts the detection signals output from the three respective hitting sensors 104 into digital signals or an MIDI converter that generates MIDI signals based on these detection signals. Note that it is only necessary that the number of hitting sensors 104 is one or more and is not limited to the count as described in the embodiments.

With the embodiment, the electronic cymbal 100 is configured as the one cymbal supported to the stand 90. Meanwhile, the electronic cymbal 100 can also be configured as an electronic hi-hat. That is, the electronic cymbal 100 may include two upper and lower cymbals supported to the stand 90. Alternatively, the electronic cymbal 100 may include the upper cymbal and a component to receive a descent of the upper cymbal disposed below the upper cymbal.

With this embodiment, the base body 102 is configured as the circular ring plate-shaped body (the circular plate body) in plan view. Meanwhile, the base body 102 is not limited to have the circular shape and may have any other shape such as a polygonal shape.

This disclosure also relates to an electronic cymbal that electronically achieves the acoustic cymbal or the hi-hat using the electronic circuit.

The output terminal 121 may be a jack type interface to attachably/removably connect the signal processing device and the hitting sensors 104 via the signal cable (not illustrated) to output the detection signals output from the respective hitting sensors 104 to the signal processing device disposed outside the electronic cymbal 100.

The signal processing device may generate the musical sound signals representing the musical sound based on the detection signals formed of the sum signals input from the respective hitting sensors 104 and output the musical sound signals to the external speaker.

The electronic cymbal of this embodiment may be the following first to sixth electronic cymbals.

The first electronic cymbal includes a base body, a pad, and a hitting sensor. The base body has a through-hole at a center of a circular plate body. The pad is made of a material with elasticity. The pad includes a surface hit by a player covering one surface of the base body. The hitting sensor is disposed adjacent to the through-hole on another surface side of the base body. The hitting sensor is configured to detect the hitting to the pad. The pad includes a cup portion and a joint. The cup portion bulges into a convex shape at a part opposed to a back side surface of the hitting sensor in the base body. Separation of the pad from the back side surface forms a void between the cup portion and the back side surface. The joint droops from an inner surface of the cup portion to contact the back side surface.

In the second electronic cymbal according to the first electronic cymbal, the joint is formed to have an intermittent or a continuous annular shape.

In the third electronic cymbal according to the first or the second electronic cymbal, the pad further includes an isolation support pillar. The isolation support pillar droops from the inner surface of the cup portion and is opposed to the back side surface via a clearance. The clearance between the isolation support pillar and the back side surface has an amount of clearance where the isolation support pillar contacts the back side surface when the player hits the pad.

In the fourth electronic cymbal according to the third electronic cymbal, the isolation support pillar is formed to have a thickness thicker than the joint.

In the fifth electronic cymbal according to the third or the fourth electronic cymbal, the isolation support pillar is formed to have an intermittent or a continuous annular shape at a position radially inside the pad with respect to the joint.

In the sixth electronic cymbal according to the any one of the first to the fifth electronic cymbals, the joint is tapered off to the back side surface.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electronic cymbal comprising:
a base body having a through-hole at a center;
a pad made of a material with elasticity, the pad including a surface hit by a player with the surface covering a first surface of the base body; and
a hitting sensor disposed adjacent to the through-hole on a second surface side of the base body, the hitting sensor being configured to detect hitting to the pad, wherein
the pad includes a cup portion, the cup portion includes a part of the pad opposed to a position corresponding to a back side of the hitting sensor in the first surface of the base body, the part bulging into a convex shape and being separated from the first surface, the cup portion forming a void between the cup portion and the first surface by the separation, and
the pad further includes a joint, the joint drooping from an inner surface of the cup portion to contact the first surface of the base body.

2. The electronic cymbal according to claim 1, wherein
the joint is formed to have an intermittent or a continuous annular shape.

3. The electronic cymbal according to claim 1, wherein
the pad further includes an isolation support pillar, the isolation support pillar drooping from the inner surface of the cup portion and being opposed to the first surface of the base body via a clearance, and
the clearance between the isolation support pillar and the first surface has an amount of clearance where the isolation support pillar contacts the first surface when the player hits the pad.

4. The electronic cymbal according to claim 2, wherein
the pad further includes an isolation support pillar, the isolation support pillar drooping from the inner surface of the cup portion and being opposed to the first surface of the base body via a clearance, and
the clearance between the isolation support pillar and the first surface has an amount of clearance where the isolation support pillar contacts the first surface when the player hits the pad.

5. The electronic cymbal according to claim 3, wherein
the isolation support pillar is formed to have a thickness thicker than the joint.

6. The electronic cymbal according to claim 4, wherein
the isolation support pillar is formed to have a thickness thicker than the joint.

7. The electronic cymbal according to claim 3, wherein
the isolation support pillar is formed to have an intermittent or a continuous annular shape at a position radially inside the pad with respect to the joint in the inner surface of the cup portion.

8. The electronic cymbal according to claim 4, wherein
the isolation support pillar is formed to have an intermittent or a continuous annular shape at a position radially inside the pad with respect to the joint in the inner surface of the cup portion.

9. The electronic cymbal according to claim 5, wherein
the isolation support pillar is formed to have an intermittent or a continuous annular shape at a position radially inside the pad with respect to the joint in the inner surface of the cup portion.

10. The electronic cymbal according to claim 6, wherein
the isolation support pillar is formed to have an intermittent or a continuous annular shape at a position radially inside the pad with respect to the joint in the inner surface of the cup portion.

11. The electronic cymbal according to claim 1, wherein
the joint is tapered off to the first surface of the base body.

12. The electronic cymbal according to claim 2, wherein
the joint is tapered off to the first surface of the base body.

13. The electronic cymbal according to claim 3, wherein
the joint is tapered off to the first surface of the base body.

14. The electronic cymbal according to claim 4, wherein
the joint is tapered off to the first surface of the base body.

15. The electronic cymbal according to claim 5, wherein
the joint is tapered off to the first surface of the base body.

16. The electronic cymbal according to claim 6, wherein
the joint is tapered off to the first surface of the base body.

17. The electronic cymbal according to claim 7, wherein
the joint is tapered off to the first surface of the base body.

18. The electronic cymbal according to claim 8, wherein
the joint is tapered off to the first surface of the base body.

19. The electronic cymbal according to claim 9, wherein
the joint is tapered off to the first surface of the base body.

20. The electronic cymbal according to claim 10, wherein
the joint is tapered off to the first surface of the base body.
